(19) United States
(12) Patent Application Publication
(10) Pub. No.: US 2015/0144364 A1
(43) Pub. Date: May 28, 2015

(54) Operator-Portable Power Supply of Maximum Specific Energy

(71) Applicant: David Barron, Austin, TX (US)

(72) Inventor: David Barron, Austin, TX (US)

(73) Assignee: David Barron, Austin, TX (US)

(21) Appl. No.: 14/559,919

(22) Filed: Dec. 4, 2014

(51) Int. Cl. B25B 33/00; B25B 29/00

(52) U.S. Cl. CPC B25B 33/00; B25B 29/00
USPC 173/1; 173/46

(57) ABSTRACT

The present invention relates to a system and method for providing power of maximum relevant specific energy. The system is more particularly defined as an operator-portable power supply utilizing a fuel containing hydrogen peroxide for energy, coupled with water and oxygen recovery, storage and delivery means. Extracting energy, water, and oxygen from the hydrogen peroxide fuel and refining to consumable forms (electrical, pneumatic, hydraulic, etc. energy; potable water; breathable oxygen) is for the purpose of increasing the overall energy output of the power supply per carried mass. The resultant water displaces water otherwise requiring transportation by the operator and the oxygen allows for hyperoxic respiration, increasing the metabolic power output of the operator.

### FIELD OF THE INVENTION

The present invention relates to a system and method for providing power of maximum relevant specific energy. The system is more particularly defined as an operator-portable power supply utilizing a fuel containing hydrogen peroxide for energy, coupled with water and oxygen recovery, storage and delivery means. Extracting energy, water, and oxygen from the hydrogen peroxide fuel and refining to consumable forms (electrical, pneumatic, hydraulic, etc. energy; potable water; breathable oxygen) is for the purpose of increasing the overall energy output of the power supply per carried mass. The resultant water displaces water otherwise requiring transportation by the operator and the oxygen allows for hyperoxic respiration, increasing the metabolic power output of the operator.

### BACKGROUND OF THE INVENTION

Currently, there are only a few common methods to transport and carry energy in operator-portable systems: fossil based fuels (such as gasoline, diesel, and Jet-A) and batteries (such as lithium-ion, nickel-metal hydride, and others).

One element required for the analysis of an operator-portable power supply involves total carried mass. Many activities that would benefit from a high power, portable power supply also require the operator to carry water; operators such as firefighters, soldiers and disaster recovery workers (human or animal) carry gallons of water for any given mission. Any power supply that reduces the need to carry this water increases the effective specific energy (energy/carried mass) and is thus a better power supply for operator-portable applications.

Another further element required for the analysis of an operator-portable supply is the different forms of energy that can be utilized. For instance, an ideal application of a portable power supply is for human augmentation of soldiers and firefighters; while muscle augmentation in the form of mechanical energy is a principle goal, an equally important metric is performance gains induced by other forms of energy. An example of this is hyperoxia, where inhaling air with greater than normal percent oxygen induces athletic performance and cognitive gains. Studies have recorded an increased work output of >5% during hyperoxia; other studies have shown that hyperoxia decreases reaction time during strenuous activity.

Fossil based fuels are the key energy carrier for any means of large scale locomotion such as land, air, and water vehicles. The advantages of fossil based fuels are numerous and include high specific energy (raw lower heating values on the order of 45 MJ/kg), reliable operation, and fairly easy transport. They are combusted in a variety of different engines to provide both mechanical and electrical energy. The exhausted products of fossil-fuel based engines are toxic gases that are released to the atmosphere and of no use; essentially, the by-products of combustion are waste. Furthermore, the exhaust gasses leave distinct and traceable compounds which do not allow for discrete operation. Discrete operation is further hindered by the noise produced by the combustion engine.

Typical gasoline engines have efficiencies on the order of 20% to 25% in cars, but that number degrades rapidly as the engine gets smaller; hobby IC gas engines have efficiencies closer to 8%. Applying this efficiency to the specific energy of gasoline causes a reduction in the lower heating value from 45 MJ/kg to 8.9 MJ/kg for car engines and to 3.60 MJ/kg for hobby IC gas engines. For the purpose of this specification, the estimated 3.60 MJ/kg is especially important as hobby sized IC gas engines are considered one of the primary technologies for future investment in portable power supplies.

Unlike energy stored in gasoline and other chemical fuels, batteries output useable electrical energy and do not suffer from significant losses during release. This is one reason why, for smaller scale energy storage, batteries are the most widely used energy storage technology. They are portable and directly output electrical energy. Batteries are typically used in low power applications such as portable electronics and smaller drones/UAVs/UAWs; they are also used in any application where atmospheric oxygen is not readily available. Batteries, however, suffer from low specific energy (typically less than 1 MJ/kg), which puts a cap on the total power output of a portable power supply.

A power supply featuring a fuel containing hydrogen peroxide as an energy carrier addresses issues with both fossil fuels and batteries. Research and development has been done by numerous parties to utilize hydrogen peroxide as an effective power carrier. Decomposition of high test hydrogen peroxide (HTP; hydrogen peroxide in concentrations greater than 85%) was used as a monopropellant in torpedoes as far back as 1957 by the Russian Navy; HTP decomposition was also used in the widely publicized Bell Rocket Belt which would carry a man up to 9 meters in the air for durations up to about 30 seconds. Neither of these systems utilized the products of decomposition as a consumable resource.

Other work has focused on portable applications of a hydrogen peroxide based power supply. A large majority of the work has been carried out by Professor Homayoon Kazerooni and his team at the University of California Berkeley with respect to an exoskeleton power supply. In their publication, “The Design and Testing of a Monopropellant Powered Free Piston Hydraulic Pump”, HTP was used as a monopropellant in a portable power supply. While the results were generally positive, there is no mention in the publications or the related patent, U.S. Pat. No. 7,628,766, for a system allowing for the consumption of the products of the HTP decomposition for the purpose of reducing carried mass (water; effectively increasing the specific power of the supply) nor for the purpose of performance gains associated with hyperoxia.

U.S. Pat. No. 6,935,109 and associated publication (Design and Energetic Characterization of a Liquid-Propellant-Powered Actuator for Self Powered Robots) from Vanderbilt University details an actuator for mobile robots powered by HTP, but does not detail the consumption of HTP decomposition products to increase the effective specific energy nor hyperoxia.

U.S. Pat. No. 8,147,760 describes a portable oxygen generation system where hydrogen peroxide is decomposed and the resultant oxygen passed through a filter impregnated with catalyst particles to decompose lingering hydrogen peroxide vapor. There is however, no mention of capturing or using the energy released through the decomposition of the hydrogen peroxide (meaning there is also no notion of specific energy), nor any mention of using the released oxygen to induce hyperoxia.

U.S. Pat. No. 5,932,940 describes a micro-gas turbine on such a scale as to be practical in a portable power supply. The disclosure also includes reference to the use of hydrogen peroxide and catalyst as a potential fuel, but there no mention or contemplation of a method to capture the resultant chemical products of the turbine.

U.S. Pat. No. 3,581,504 discloses a gas generator with a reference to hydrogen peroxide as a monopropellant fuel and decomposed with a catalyst. The system is focused on creating pressure differentials and does not include a method to capture the resultant chemical products of the gas generator for consumption.

U.S. Pat. No. 6,255,009, details the decomposition of hydrogen peroxide to produce energy, breathing oxygen, and potable water with a focus on large scale power production for land vehicles, spacecraft, aerial vehicles, and maritime vessels with a key emphasis on carriers and submarines. The invention does not discuss any operator-portable system where specific energy and carried mass is paramount in dictating overall operator efficiency. It does not contemplate a system where the specific energy of the power supply is increased by using at least one of the substances remaining after extracting energy from hydrogen peroxide to offset mass which would otherwise require transport. It also does not contemplate any useage of the oxygen for performance benefits associated with hyperoxia.

Another option for energy extraction from hydrogen peroxide is direct chemical to electrical energy through the use of a fuel cell. The most relevant fuel cells developed to date are direct hydrogen peroxide fuel cells as described in the following publications: “A membraneless hydrogen peroxide fuel cell using Prussian Blue as cathode material” by Shaegh, Trung, Ehteshami and Chan and “Enhanced Performance of Membraneless Fuel Cells” by Gowdhamamoorthi, Arun, Kiruthika, and Muthukumaran. Neither of these publications discuss any operator-portable system where the products of the hydrogen peroxide fuel cell are used to effectively increase the specific energy by reducing the need to carry water or utilization of produced oxygen for performance gains associated with hyperoxia.

There is a need in the art for a portable power supply of maximum specific energy where said maximum is attained by consumption of the reaction product(s) in order to reduce the carried load and extract performance gains.

### SUMMARY OF INVENTION

The present system relates to an operator-portable power supply which utilizes hydrogen peroxide to produce energy and other substances to increase the specific energy of the power supply. This is accomplished by using the operator portable power supply to output consumable water which offsets mass otherwise requiring transport and/or outputting breathable oxygen in order to induce hyperoxia providing for increased operator metabolic output.

### BRIEF DESCRIPTION OF DRAWINGS

The following drawings form part of the present specification and are included to further demonstrate certain aspects of the present invention. The invention may be better understood by reference to one or more of these drawings in combination with the detailed description of illustrative embodiments presented herein. These drawings illustrate by way of example and not limitation, and they use like references to indicate similar elements. The drawings include:

FIG. 1—a schematic block diagram mapping the energy and mass of the system including phase of the mass;

FIG. 2—a schematic block diagram of the basic hardware elements in preferred embodiments;

FIG. 3—a schematic block diagram of a preferred embodiment of the invention utilizing decomposition of the hydrogen peroxide fuel and energy extraction via expansion of resulting hot gasses;

FIG. 4—a piping and instrumentation diagram depicting a specific embodiment utilizing decomposition of the hydrogen peroxide fuel directly actuating pneumatic actuators;

FIG. 5—a piping and instrumentation diagram depicting a specific embodiment utilizing decomposition of the hydrogen peroxide fuel and a turbine for conversion to mechanical energy;

FIG. 6—a schematic block diagram of a preferred embodiment of the invention utilizing a hydrogen peroxide fuel cell for energy extraction;

FIG. 7—a piping and instrumentation diagram depicting a specific embodiment utilizing a fuel cell for energy extraction from fuel containing hydrogen peroxide;

FIG. 8—a piping and instrumentation diagram depicting a method of improving efficiency of some embodiments of the invention;

FIGS. 9A and 9B—a set of piping and instrumentation diagrams depicting different methods for hydrogen peroxide delivery.

### DETAILED DESCRIPTION OF THE PREFERRED EMBODIMENTS

Embodiments described herein are applicable to a wide range of different applications. Foremost, the power supply can be used to power operator-portable (specifically man-portable), robotics for human augmentation in such a manner as to maximize the specific energy. However, with the aid of this disclosure, it will be apparent to those skilled in the art that this technology is applicable to many other uses.

In numerous embodiments, the system releases chemical energy to various other forms of energy such as electrical or mechanical and also utilizes the remnants of the chemical energy carrier as useable substances. Utilization of the remnants of the chemical energy carrier maximizes the energy per carried mass of the power supply system.

Specifically, numerous embodiments utilize a fuel containing hydrogen peroxide as a chemical energy carrier; hydrogen peroxide has a lower heating value on the order of 1.6 MJ/kg and a higher heating value of 2.9 MJ/kg. H₂O and oxygen in mass ratios of 53% and 47% respectively are the substances remaining after energy is released from a pure hydrogen peroxide fuel. Given that both soldiers and US wildfire fighters typically must carry around two gallons of water, these two gallons can be carried in the hydrogen peroxide fuel. In this way, the weight of the water embedded in the hydrogen peroxide can be deducted when calculating the heating values of hydrogen peroxide in a portable power supply. Using this method, the effective lower and upper heating values of hydrogen peroxide are increased to 3.40 and 6.17 (MJ/carried kg) respectively; these increased heating values are applicable up to the desired quantity of resultant water. In order to realize this effective increase in specific energy, a system for extracting energy and capturing, refining, and storing the resultant H₂O is described.

Energy released through the decomposition of hydrogen peroxide to water and oxygen can utilize the expansion of hot product gasses (steam and oxygen) to perform work. The specific energy of hydrogen peroxide, given typical efficiencies of 9-12% applied to the lower heating value, is on the order of 0.41 (MJ/carried kg). If the chemical energy stored in hydrogen peroxide is released via a direct hydrogen peroxide fuel cell the efficiency is on the order of 25% and is predicted to rise to around 70% with improvements in technology; these efficiencies are applied to the higher heating value, which results in effective specific energy of around 1.54 and 4.32 (MJ/carried kg), respectively; the latter represents a 20% increase compared to hobby sized IC engines.

The other substance released when energy is extracted from hydrogen peroxide is oxygen. While not calculated here, utilizing this oxygen for athletic and cognitive benefits induced by hyperoxia during periods of increased physical activity can also increase the effective specific energy of a fuel containing hydrogen peroxide. For this reason, numerous embodiments incorporate methods for capturing, refining, storing, and delivering the oxygen for the purpose of hyperoxic respiration.

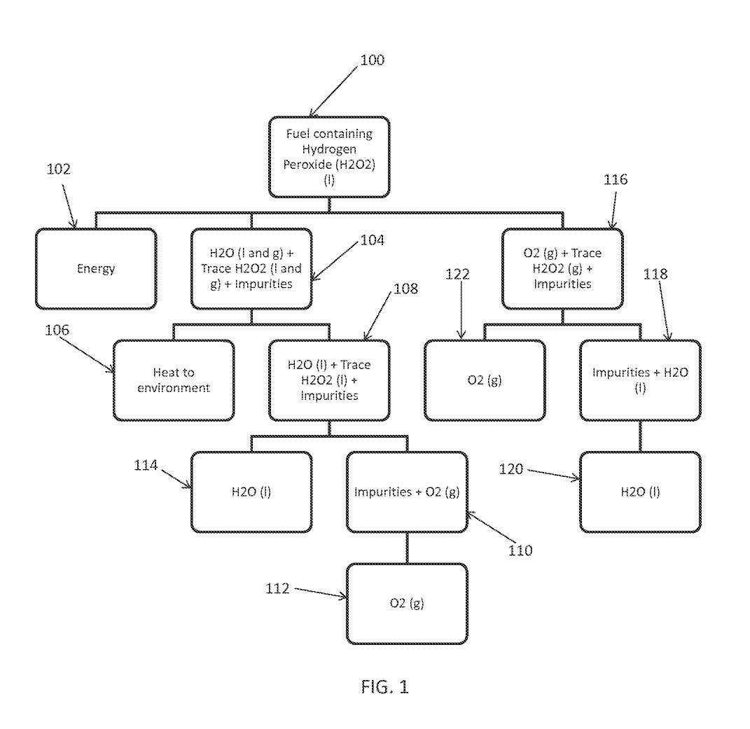

In one of the most basic ways, an embodiment of this invention can be described by the flow of mass and energy within the system, as well as the thermodynamic phases of the compounds throughout the system, as is done in FIG. 1. FIG. 1 maps the flow of mass, energy, and phase change throughout a general embodiment. The fuel containing hydrogen peroxide, 100, is stored in the liquid phase and is used to store energy for the power supply. Releasing the chemical energy in the hydrogen peroxide results in: energy in a useable form, 102; water in the liquid and gas phase tainted with impurities and lingering hydrogen peroxide, 104; and oxygen in the gas phase tainted with impurities and lingering hydrogen peroxide, 116. The energy, 102, can be manipulated and directed towards load or storage after extraction from the hydrogen peroxide, 100.

The H₂O tainted with impurities and hydrogen peroxide in the liquid and gas phase, 104, may be manipulated into consumable forms and used to increase the effective specific energy of the power supply. From a phase perspective, one method of accomplishing this is to extract enough heat, 106, to reduce the temperature below the dew point, such that the water and remaining hydrogen peroxide, both with impurities, 108, are in the liquid phase. Noting that the trace hydrogen peroxide can be decomposed to oxygen and more water, the solution is separated into potable liquid water, 114, as well as impurities and oxygen gas, 110. The gaseous oxygen can then be vented, resulting in breathable gaseous oxygen, 112.

The oxygen tainted with impurities and hydrogen peroxide and impurities, 116, may be manipulated into a consumable form for the purpose of inducing hyperoxia in the operator. The trace hydrogen peroxide can be decomposed, resulting in breathable gaseous oxygen, 122, while leaving the impurities and liquid water, 118. Removal of the impurities results in consumable liquid water, 120.

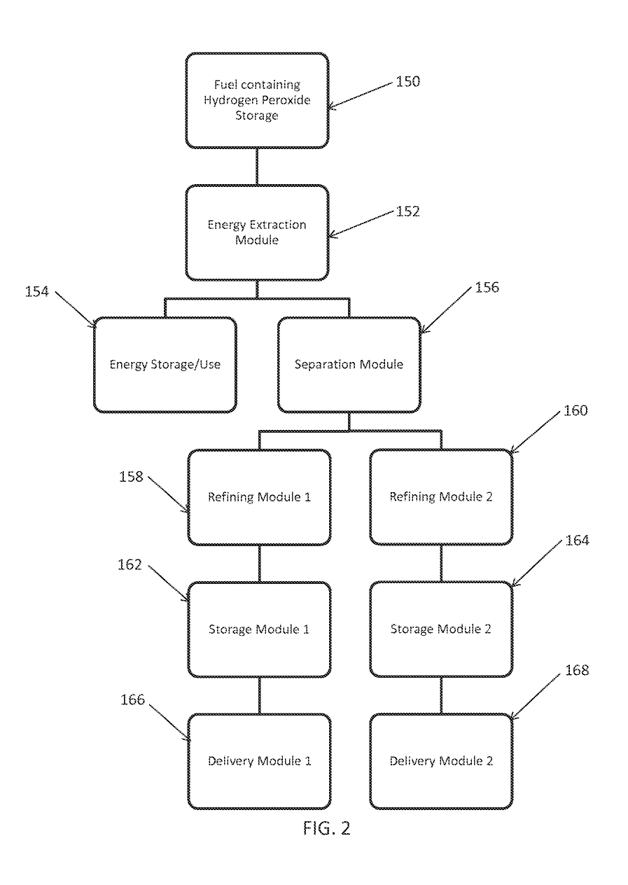

A map of basic hardware elements and flow structure of numerous embodiments is depicted in FIG. 2. First, a fuel containing hydrogen peroxide is stored in a tank, 150, suitable for the unique demands of hydrogen peroxide, which include its propensity to decompose with an increased rate due to rising temperature, pH, and presence of catalysts. The storage tank should be able to minimize decomposition as well as regulate pressure buildup due to decomposition. The energy from the hydrogen peroxide is extracted in an energy extraction module, 152, which extracts the energy from the hydrogen peroxide and directs it towards hardware entities for the storage or use of said energy, 154.

Another hardware element, 156, performs a first separation of the products remaining after energy extraction. For hydrogen peroxide, the desired products to be separated are oxygen and water. In order to purify the oxygen and water to levels of impurities less than or equal to the threshold for consumption, these products are sent to a plurality of refining modules, 158 and 160; which are shown as two, but can be as many as needed. Once at desired level of purification, the products are stored in separate modules, represented by 162 and 164, before they are eventually distributed to delivery modules, represented by 166 and 168. It is important to note that the depiction of unique and distinct modules in FIG. 2 does not imply that modules cannot be combined, but is to show the key functions and elements that are found in many embodiments.

Two sets of embodiments include unique methods of extracting energy from the fuel containing hydrogen peroxide: decomposition of hydrogen peroxide to oxygen and H₂O (in either liquid or vapor form depending on concentration of the hydrogen peroxide) and direct extraction to electrical energy via fuel cell technology.

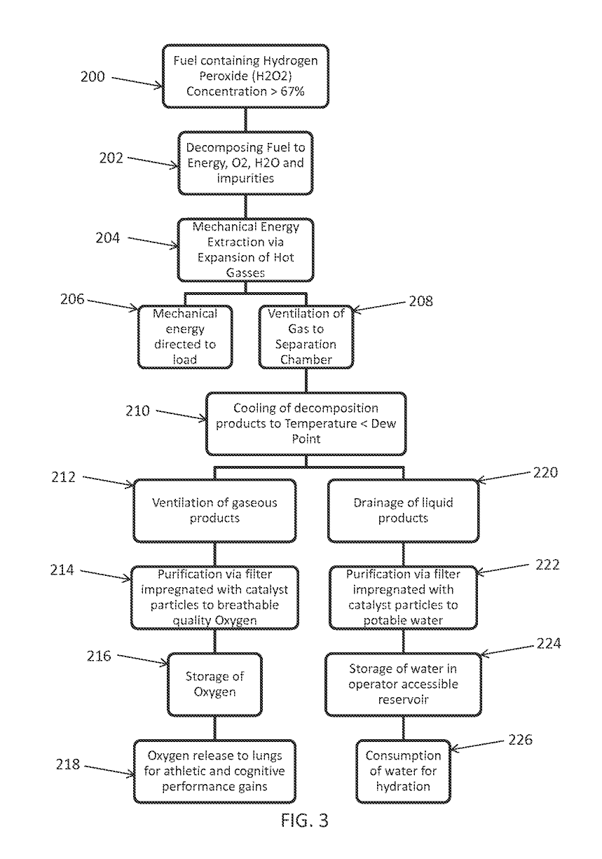

FIG. 3 presents a block diagram of a preferred embodiment utilizing energy extraction via decomposition and expansion of hot gasses. A fuel containing hydrogen peroxide of concentration greater than 67%, 200, is decomposed to thermal energy, manifested in hot oxygen gas and steam at high pressure, 202. The thermal energy is converted to mechanical energy via the expansion of these hot gasses, 204, and the mechanical energy is directed to a desired load, 206. It is important to note that hydrogen peroxide concentrations greater than 67% allow for the release of enough energy to completely vaporize the produced H₂O and are therefore preferred in this embodiment; concentrations less than 67% will not inhibit operation of embodiments utilizing decomposition of the hydrogen peroxide, but may require additional hardware and complexity that is not preferred.

After energy extraction via expansion of the hot gasses, 204, the gasses are vented to a separation chamber, 208. The products of decomposition are cooled to a temperature below the dew point, 210, such that the H₂O and oxygen can be separated via ventilation of the gaseous oxygen, 212, and drainage of the water, 220. The gaseous oxygen will then be purified such that impurities and lingering hydrogen peroxide vapor is removed. One method of accomplishing this is to pass the gaseous products through a filter impregnated with catalyst particles, 214, the filter removes any particulate impurities, while the catalyst particles decompose lingering hydrogen peroxide to water and more oxygen. The breathable oxygen is then stored, 216, and released to the lungs to extract athletic and cognitive benefits, 218, when desired.

The liquid decomposition products follow a similar path; the drained liquids are passed through a filter, 222, optimized for liquid contaminated with hydrogen peroxide. The resulting product after the filter consists of potable water, which is stored in an operator accessible reservoir, 224, before consumption or use by the operator, preferably for hydration, 226.

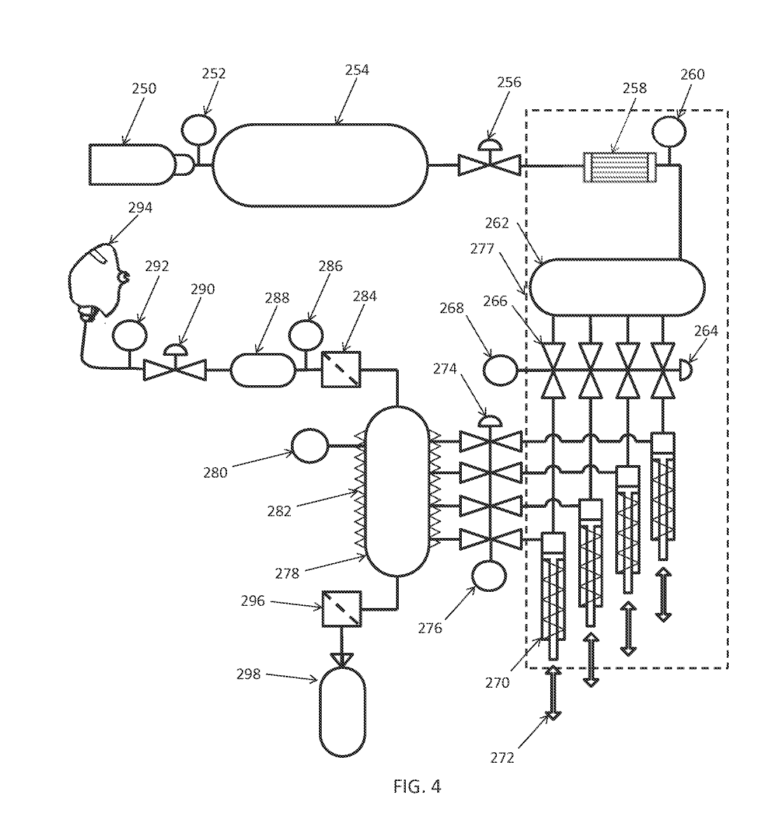

FIG. 4 details a piping and instrumentation diagram depicting a specific preferred embodiment utilizing decomposition of the hydrogen peroxide fuel directly actuating pneumatic actuators. A pressurized tank, 250, containing an inert gas, such as nitrogen, is monitored by a pressure gauge, 252, and applies pressure to the hydrogen peroxide storage tank, 254. A controlled one way valve, 256, controls the flow rate of pressurized hydrogen peroxide as energy, water, or oxygen is required/desired. When the valve is open, the pressurized hydrogen peroxide flows into the catalyst pack, 258. The catalyst pack can take several different forms, including wire meshes of, or plated with, catalyst, open cell metallic foam of, or plated with, catalyst, a liquid to liquid mixing chamber for liquid catalyst, or any other method of effectively decomposing the hydrogen peroxide. The decomposition pressure is monitored via a pressure gauge, 260; the decomposition products fill and pressurize an open volume, represented here as a tank, 262. The pressurized decomposition gasses are allowed to flow out of the tank based on the control system, 264, opening and closing one or more valves, 266, with the aid of one or more pressure gauges, 268. The opening of valves allows the hot gasses to expand in one or more pneumatic actuators, 270, for the purpose of performing work, 272. In this diagram, the actuators are depicted as one-way spring return type pneumatic cylinders, but could also be two way pneumatic cylinders, rotary pneumatic actuators, etc. given adequate piping strategies. Another valve, or plurality of valves, 274, allow the hot gasses to escape from the actuators to a storage tank, 278; another pressure gauge, 276, is of use for the control of these valves. One important feature of this decomposition system is thermal insulation of items 258 through 270 to maximize the thermal energy to mechanical energy conversion efficiency; insulation is shown as 277.

As the decomposition products enter the storage tank, 278, the temperature of the decomposition products are reduced to a temperature below the dew point, as measured by temperature and pressure gauges, 280. The method of heat dissipation shown in this embodiment is a plurality of thermally conductive surfaces for the purpose of increasing the area available for convective heat transfer, fins, 282.

Reducing the temperature of the decomposition products to less than the dew point allows for the drainage of liquid products and ventilation of vapor products. For this embodiment, the hydrogen peroxide fuel decomposition products are oxygen and H₂O, both of which will most likely be tainted with impurities and lingering hydrogen peroxide. The liquid products are passed through a filter, 296, which outputs potable water to an accessible tank, 298. The gaseous products are sent through a filter, 284, to a storage tank, 288, at a measured temperature and pressure, as measured by a gauge, 286. When the oxygen is requested by the operator, a control valve, 290, allows for the oxygen at a certain pressure, as measured by a pressure gauge, 292, to be sent to an oxygen delivery device, 294. The system of control valves (256, 266, 274, and 290) and pressure gauges (252, 260, 268, 276, 280, 286, and 292) can be utilized to ensure oxygen at optimal pressure is being delivered to the operator.

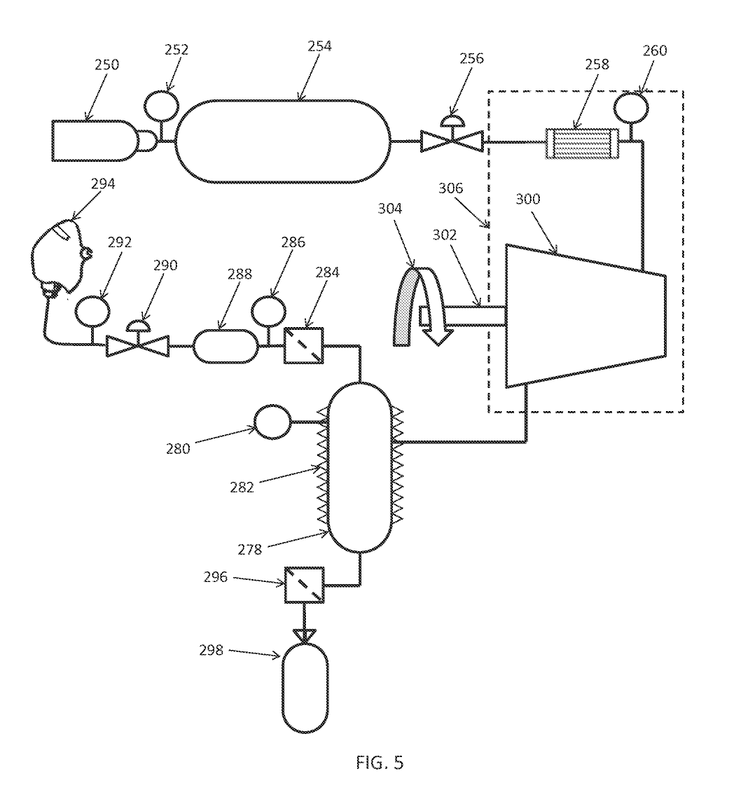

FIG. 5 is a piping and instrumentation diagram depicting a specific embodiment utilizing decomposition of the hydrogen peroxide fuel and a turbine for energy conversion to mechanical energy. Items 250 through 260, and 278 through 298 are wholly the same as FIG. 4, and are repeated in FIG. 5. FIG. 5 depicts the hot decomposition gasses from the catalyst pack, 258, at the pressure measured by gauge 260, entering an expansion type rotary turbine, 300. The expansion of the hot, gaseous, decomposition products inside the turbine causes the turbine shaft, 302, to rotate, such that the mechanical energy of the rotating shaft can be directed to a desired load, 304. Insulation, 306, is again used to improve efficiency. Substances leaving the turbine proceed to the tank, 278, and the proceeding elements are the same as in FIG. 4.

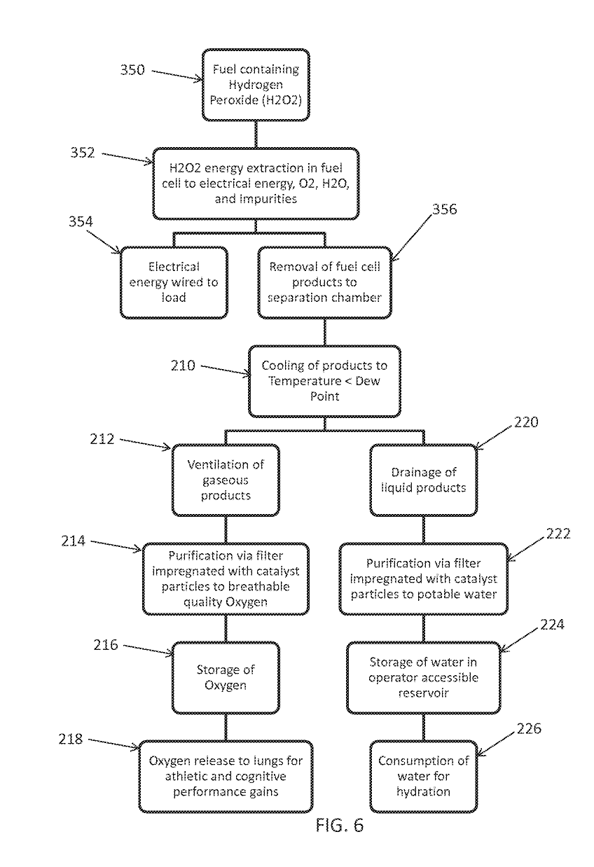

FIG. 6 is a schematic block diagram of a preferred embodiment of the invention utilizing a hydrogen peroxide fuel cell for energy extraction. Note, items 210 through 226 are wholly the same as FIG. 3, and are repeated in FIG. 6. A fuel containing hydrogen peroxide, 350, is input to a hydrogen peroxide fuel cell, 352, for the purpose of outputting electrical energy, oxygen, and H₂O plus additional unwanted impurities. The electrical energy is wired to load, 354, which could include a circuit containing storage and dissipation items. The products of the fuel cell are directed towards a separation chamber, 356. The functions of the remaining items are wholly the same as in FIG. 3.

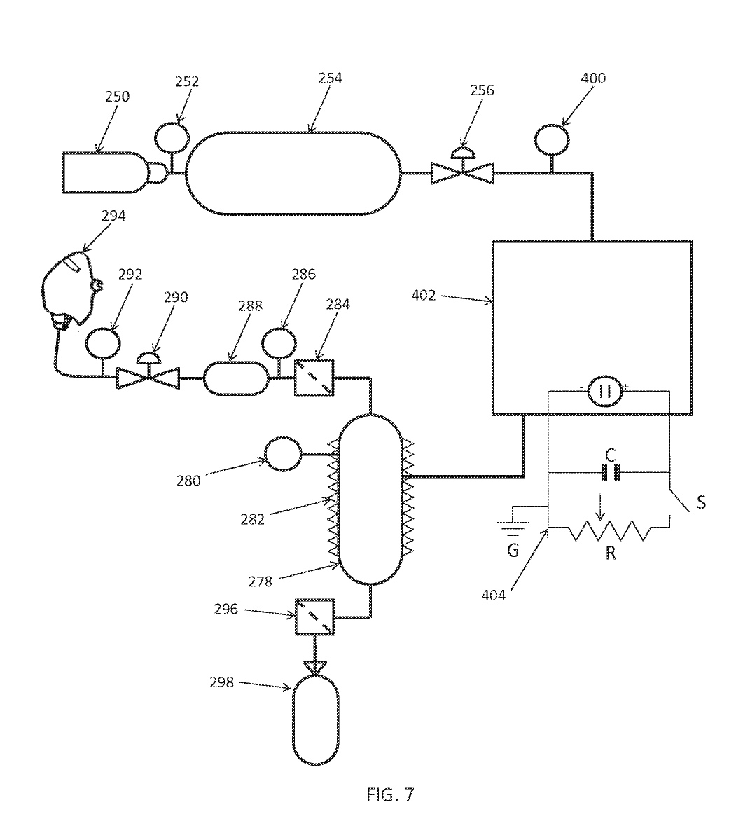

FIG. 7 is a piping and instrumentation diagram depicting a specific embodiment utilizing a fuel cell for energy extraction from hydrogen peroxide fuel. Items 250 through 256 and 278 through 298 are wholly the same as FIG. 4 and FIG. 5 and are repeated in FIG. 7. FIG. 7 shows the hydrogen peroxide is allowed to escape at the pressure indicated by a pressure gauge, 400, from the control valve, 256, to a hydrogen peroxide fuel cell, 402. The fuel cell releases electrical energy, H₂O, and oxygen along with undesired impurities and lingering hydrogen peroxide. The electrical energy is directed into a circuit, 404, preferably with the ability to both store and use the electrical energy. The products of the fuel cell move into the tank, 278, and proceed as outlined in FIG. 4 and FIG. 5.

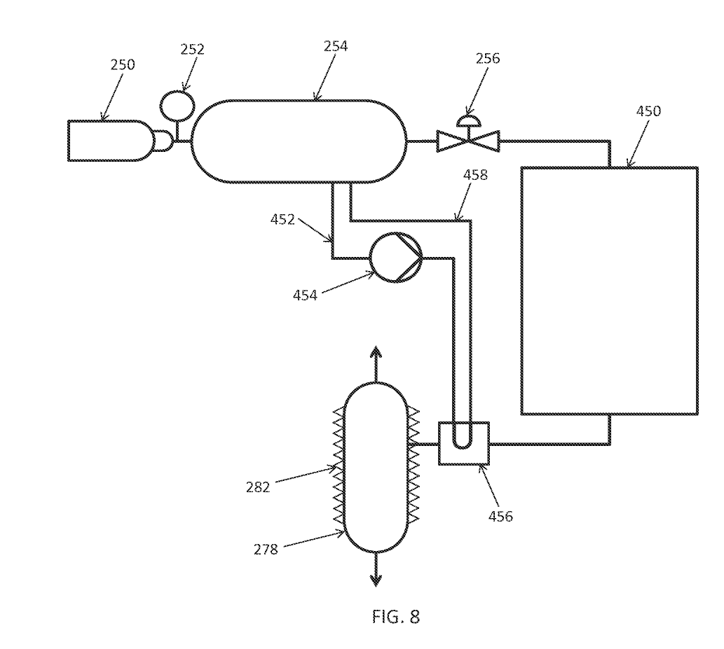

FIG. 8 is a piping and instrumentation diagram depicting a method of improving efficiency of some embodiments of the invention. For some of the embodiments, increasing the temperature of the fuel containing hydrogen peroxide before it enters the energy extraction module, 450, may be desirable to improve efficiency. One method of increasing this temperature is to utilize a portion of the heat of the products coming out of the energy extraction module. One system for doing this, is to force the hydrogen peroxide in the pressurized tank, 254, through piping, 452, via a pump, 454 to a heat exchanger, 456, before more piping, 458, takes the hydrogen peroxide back to the first tank. The products from the energy extraction module, 450, will transfer heat into the fuel containing hydrogen peroxide before going into the secondary tank, 278, where heat is dissipated to the environment via the fins, 282. The system continues from the secondary tank, 278, as in previous figures.

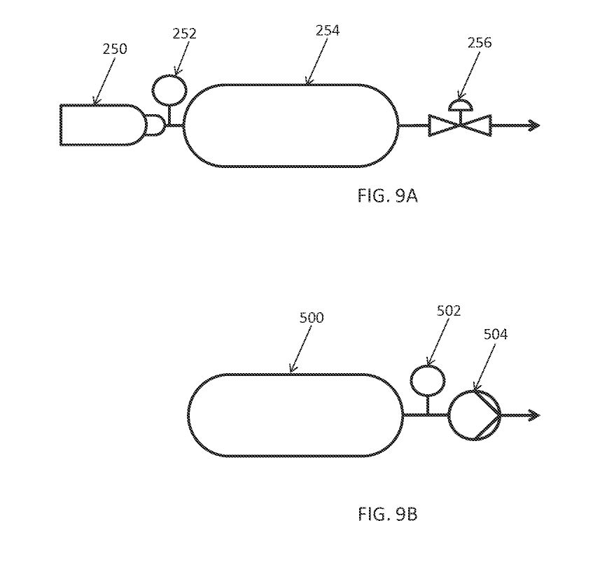

FIG. 9A is a piping and instrumentation diagram depicting the method of delivering the fuel containing hydrogen peroxide as discussed in previous figures, while FIG. 9B depicts a different method for hydrogen peroxide delivery. Items 250 through 256 are found in FIG. 4, FIG. 5, FIG. 7, and FIG. 8; the goal of these items is to deliver the fuel containing hydrogen peroxide at an elevated pressure and flow rate via compression with an inert gas. An alternative method is shown with items 500 through 504. A fuel containing hydrogen peroxide in a tank, 500, at nominally atmospheric pressure, as measured by a pressure gauge, 502, is input to the rest of the system at an elevated pressure and/or flow rate via a pump, 504.

The foregoing summary, descriptions, and drawings of the invention are not intended to be limiting, but are only exemplary of the inventive features which are defined in the claims.

What is claimed is:

1. An operator-portable power supply system comprising:
a. a fuel containing hydrogen peroxide;
b. at least one energy extraction module for extracting energy from said fuel containing hydrogen peroxide;
c. at least one separation module for the separation of at least one product from the substances remaining after energy extraction;
d. at least one refining module for the purification of at least one of said products below a threshold of impurity suitable for operator consumption;
e. at least one storage module for storing at least one of said products suitable for operator consumption prior to use.
f. at least one delivery modules for delivering at least one of said products to said operator

2. The operator-portable power supply system of claim 1, where one of said products is H₂O.

3. The operator-portable power supply system of claim 1, where one of said products is O₂.

4. The operator-portable power supply system of claim 1, where said energy extraction module includes a catalyst to decompose said fuel containing hydrogen peroxide.

5. The energy extraction module of claim 4, where the said energy extraction module includes at least one pneumatic cylinder to expand hot gaseous decomposition products and perform work.

6. The energy extraction module of claim 4, where the said energy extraction module includes at least one turbine to expand hot gaseous decomposition products and perform work.

7. The operator-portable power supply system of claim 1, where said energy extraction module includes a hydrogen peroxide fuel cell.

8. The operator of claim 1, where said operator is a human.

9. The operator of claim 1, where said operator is a service animal.

10. A method for providing power to an operator of increased energy per carried mass comprising:
a. Carrying a fuel containing hydrogen peroxide instead of carrying water;
b. Extracting energy and other substances including H₂O from said fuel containing hydrogen peroxide;
c. Directing said energy to a load;
d. Separating said H₂O from said other substances;
e. Utilizing said H₂O as said displaced carried water would have been used;

11. The method of claim 10, where said extracting further comprises decomposing said fuel containing hydrogen peroxide with a catalyst and forming hot gaseous decomposition products.

12. The method of claim 11, where said hot gaseous decomposition products are expanded to perform work.

13. The method of claim 10, where said extracting further comprises supplying said fuel containing hydrogen peroxide to a fuel cell.

14. A method for providing power to an operator of increased energy per carried mass comprising:
a. Extracting energy and other substances including O₂ from a fuel containing hydrogen peroxide;
b. Directing said energy to a load;
c. Separating said O₂ from said other substances;
d. Purifying said O₂ below a threshold of impurity suitable for operator consumption;
e. Delivering said O₂ to said operator in such a manner as to induce hyperoxic respiration.

15. The method of claim 14, where said extracting further comprises decomposing said fuel containing hydrogen peroxide with a catalyst and forming hot gaseous decomposition products.

16. The method of claim 15, where said hot gaseous decomposition products are expanded to perform work.

17. The method of claim 14, where said extracting further comprises supplying said fuel containing hydrogen peroxide to a fuel cell.

18. The operator of claim 14, where said operator is a human.

19. The operator of claim 14, where said operator is a service animal.
